(19) United States
(12) Patent Application Publication
(10) Pub. No.: US 2022/0398636 A1
(43) Pub. Date: Dec. 15, 2022

(54) Music Distribution Systems and Related Methods Using Cryptocurrency and Non-Fungible Tokens

(71) Applicants: Raymond Fikes, Mesa, AZ (US); Dennis R. Westbrook, Mesa, AZ (US)

(72) Inventors: Raymond Fikes, Mesa, AZ (US); Dennis R. Westbrook, Mesa, AZ (US)

(21) Appl. No.: 17/806,259

(22) Filed: Jun. 9, 2022

Related U.S. Application Data
(60) Provisional application No. 63/208,843, filed on Jun. 9, 2021.
(60) Provisional application No. 63/208,700, filed on Jun. 9, 2021.

(51) Int. Cl. G06Q 30/02; G06Q 20/12; G06Q 20/38

(52) U.S. Cl. CPC G06Q 30/0282; G06Q 20/1235; G06Q 20/389; G06Q 2220/165

(57) ABSTRACT

Implementations of a method of generating a non-fungible token of a song may include receiving an upload of a song from an artist; receiving proof of copyright registration; performing an intellectual property rights check of the song; and receiving funds from the artist for a desired number of critiques of the song. The method may include receiving a selection of a category of the song from the artist; receiving, from the artist, a selection of a percentage of ownership of a non-fungible token of the song available for sharing; and generating the non-fungible token of the song along with an associated predetermined number of financial non-fungible tokens using the web server and a block chain system coupled thereto. The method may also include allocating the financial non-fungible tokens according to the selection of the percentage of ownership of the non-fungible token using the block chain system.

### CROSS REFERENCE TO RELATED APPLICATIONS

This document claims the benefit of the filing date of U.S. Provisional Patent Application 63/208,843, entitled “Music Distribution Systems and Related Methods Using Cryptocurrency and Non-Fungible Tokens” to Fikes et al., which was filed on Jun. 9, 2021 ('843 Provisional) and also claims the benefit of the filing date of U.S. Provisional Patent Application 63/208,700, entitled “Blockchain Systems and Related Methods,” to Raymond Fikes, which was filed on Jun. 9, 2021 ('700 Provisional), the disclosures of each of which are hereby incorporated entirely herein by reference.

### BACKGROUND

### 1. Technical Field

Aspects of this document relate generally to systems and methods for entertainment, such as systems for distributing artistic works. More specific implementations involve streaming systems.

### 2. Background

Various systems have been devised to share artistic works. For example, movie production houses work to evaluate, produce, and then work with movie theaters to ensure that the produced movie is available for movie goers to watch. Following release of a film in a theater, the film can then released by the production house on various streaming platforms and in stores via physical media copies of the works. An example of a music distribution system called Charity Records and Music Pipeline (“The Music Marketplace”) that dated to 2002 is discussed in detail in para. [0003]-[0010] in the '843 Provisional previously incorporated by reference.

### SUMMARY

Implementations of a method of generating a non-fungible token of a song may include receiving an upload of a song from an artist using a web server; receiving proof of copyright registration from the artist using a web server; performing an intellectual property rights check using the song and the web server; and receiving funds from the artist for a desired number of critiques of the song using the web server. The method may include receiving a selection of a category of the song from the artist using the web server; receiving, from the artist using the web server, a selection of a percentage of ownership of a non-fungible token of the song available for sharing; and generating the non-fungible token of the song along with an associated predetermined number of financial non-fungible tokens using the web server and a block chain system coupled thereto. The method may also include allocating the financial non-fungible tokens according to the selection of the percentage of ownership of the non-fungible token using the block chain system.

Implementations of a method of generating a non-fungible token may include one, all, or any of the following:

The method may include wherein the proof of copyright registration may be a copyright registration certificate.

The method may include wherein proof of copyright registration may include an affidavit of authorship by the artist.

The block chain system may include blocks formed using snapshot hashing.

The percentage of ownership may be between zero percent and 40 percent and the ownership may be divided between one of a critical artist, a co-artist, a recording artist, a charity, or any combination thereof.

Implementations of a method of providing a critique of a song associated with a non-fungible token may include providing a notification to a critical artist that a song may be available for critique in a song database using a web server and a critical artist computing device. The method may include, in response to a request from the critical artist provided by the critical artist computing device, streaming the song to the critical artist computing device for review by the critical artist using the web server and the song database. The method may include receiving at least a songwriting rating and a vocals rating from the critical artist using the critical artist computing device and the web server; receiving a request to purchase one or more financial non-fungible tokens associated with a non-fungible token of the song from the critical artist computing device; and calculating an aggregate score for the song using at least the songwriting rating and the vocals rating using the web server. The method may include crediting an account associated with the critical artist a predetermined amount of cryptocurrency after receiving at least the songwriting rating and the vocals rating using the web server and a block chain system; and calculating a global average score for the song by averaging a plurality of aggregate scores for the song received from a plurality of critical artists using the web server. The method may include assigning points to the critical artist based on a numerical distance the aggregate score for the song deviates from the global average score using the web server; calculating a valuation of the non-fungible token of the song using a total number of critiques purchased by the artist of the song using the web server; and assigning the valuation to the non-fungible token using the web server and the block chain system.

Implementations of a method of providing a critique of a song associated with a non-fungible token may include one, all, or any of the following:

The method may include receiving a request to purchase one or more financial non-fungible tokens associated with a non-fungible token of the song from the critical artist computing device.

The method may include wherein receiving at least a songwriting rating and a vocals rating from the critical artist further may include receiving a production rating.

The method may include wherein calculating a valuation of the non-fungible token of the song further may include, using the web server: assigning a currency value to each possible aggregate score of a plurality of aggregate scores, the plurality of aggregate scores including integer values between 1 and 10; multiplying a count of identical aggregate scores provided by the plurality of critical artists critiquing the song at each integer value by the currency value to form a set of aggregate score valuations; adding the set of aggregate score valuations to form a total valuation; dividing the total valuation by a total number of aggregate scores provided by a plurality of critical artists critiquing the song to form an average assigned value for the song; and subtracting the average assigned value for the song from a total amount of currency paid by the artist for the total number of aggregate scores to form a surplus value.

The method may further include where if the surplus value is positive, then the surplus value may be retained and used to pay expenses and promotions offered using the web server and the block chain system.

The method may include where if the surplus value is negative, then an account associated with an artist of the song may be credited with an amount of cryptocurrency equal to a value of the surplus value as a promotion.

The method may include where the non-zero currency value may be only assigned to aggregate scores of between 4 and 10.

The method may include where assigning points to the critical artist based on the numerical distance the aggregate score for the song deviates from the global average score further may include: assigning two points if the numerical distance if the distance is zero; assigning one point if the numerical distance is one; assigning zero points if the numerical distance is two; and assigning negative one points if the numerical distance is three.

Implementations of the method may include where if the numerical distance is zero, the method further may include awarding a portion of a block reward in cryptocurrency to the account associated with the critical artist.

Implementations of a method of rewarding a user for streaming a song may include receiving a request to stream a song included in a song database at a web server from a user utilizing a user computing device; streaming the song to the user computing device using the web server and the song database; and during streaming, using the user computing device, recording hashing data. The hashing data may include at least a media access control address (MAC address) of the user computing device, an identity of an artist of the song, a system identifier of the song, a reporting node of a block chain system, a number of nodes of the block chain system chosen to report song data, and a time location within a duration of the song in milliseconds. The method may include reporting the hashing data to the reporting node of the block chain system using the user computing device; forming a hash with the hashing data using the block chain system; and if the block chain system uses the hash to secure a block of the block chain, depositing a portion of a block reward associated with the hash in cryptocurrency in an account associated with the user.

Implementations of a method of rewarding a user for streaming a song may include one, all, or any of the following:

The song database may be a third party song database controlled by a third party and the hashing data further may include an identity of the third party.

Computer readable instructions may be included in a memory of the user computing device and configured to enable the recording of hashing data in the memory.

The direction of reporting of the hashing data to the reporting node may be only from the user computing device to the reporting node.

Each block of the block chain system may be formed using snapshot hashing carried out by the block chain system.

The portion of the block reward provided by the account of the user may be determined by an allocation set by a validator of the block chain system.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a flow diagram of an implementation of a method of generating a non-fungible token (NFT) of a song;

FIG. 2 is a flow diagram of an implementation of a method of providing a critique of a song associated with an NFT;

FIG. 3 a flow diagram of a first implementation of a method of rewarding a user for streaming a song;

FIG. 4 is a flow diagram of a second implementation of a method of rewarding a user for streaming a song;

FIG. 5 is a flow diagram of a method of using a validator to add transaction blocks to a block chain; and

FIG. 6 is a block diagram of an implementation of a music distribution system.

### DESCRIPTION

This disclosure, its aspects and implementations, are not limited to the specific components, assembly procedures or method elements disclosed herein. Many additional components, assembly procedures and/or method elements known in the art consistent with the intended music distribution systems and related methods will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such music distribution systems, related methods, and implementing components and methods, consistent with the intended operation and methods.

Various music distribution system and method implementations are disclosed in the '843 Provisional that may utilize any of the block chain system and block chain implementations, including snapshot hashing disclosed in the '700 Provisional. Furthermore, additional music distribution system implementations and block chain systems and related methods are disclosed in the paper by Fikes et al, “Rhythm Coin Rhythm-Metaverse,” filed herewith as Appendix A, the disclosure of which is hereby incorporated entirely herein by reference. Any of the system and/or method implementations disclosed in Appendix A may utilize any of the system and method implementations disclosed in the '843 Provisional and '700 Provisional (and vice versa). In addition, any of the system and/or method implementations disclosed in Appendix A, the '843 Provisional, and the '700 Provisional may be utilized with any of the system and/or method implementations disclosed herein.

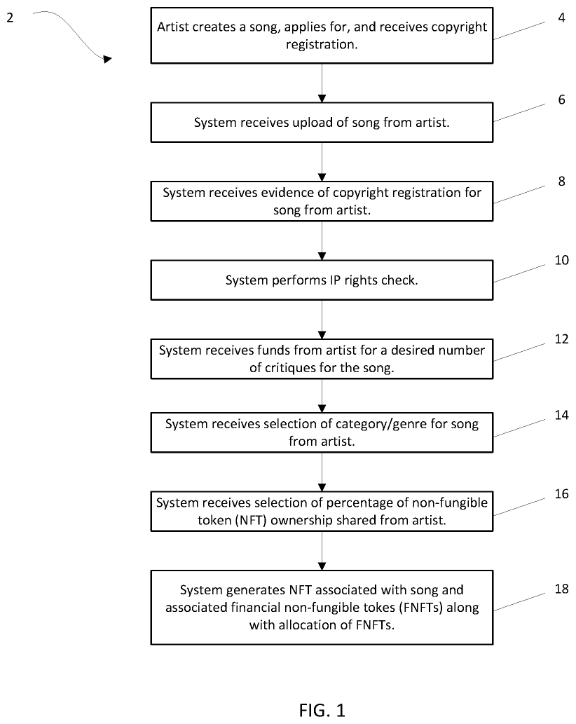

Referring to FIG. 1, a flow chart of an implementation of a method of generating a non-fungible token (NFT) of a song 2 is illustrated. As illustrated, the method begins with an artist creating a song. While the implementations disclosed in this document focus on music distribution, the principles disclosed herein may be used with other artistic works, including, by non-limiting example, video works, audio works, textual works, or any other works that can be delivered over a telecommunication channel like the internet. Also, in various implementations, the songs may be produced or unproduced and the method implementations may correspondingly vary. In various song implementations, particularly where the song is produced, there may be two or more artists/writers/recording artists who are the author, joint authors, and/or owner of a copyright to, by non-limiting example, the song, the sound recording of the song, the lyrics of the song, the sheet music of the song, the vocals of the song, the public performance rights to the song, or any other legal right(s) protected under the copyright laws of the United States or other countries, including the Berne Convention for the Protection of Literary and Artistic Works. As a first step in the process, the artist choosing to make the song available to the public via the system needs to properly account for all of the interests of any joint author or author of any part of the song (i.e., the recording artist's rights in the sound recording). The various method implementations require that this accounting/assignment of rights, etc. has taken place prior to the uploading of the song to the system. Furthermore, as illustrated in FIG. 1, the system may require that the artist have applied for and received a copyright registration with an appropriate governmental authority (step 4).

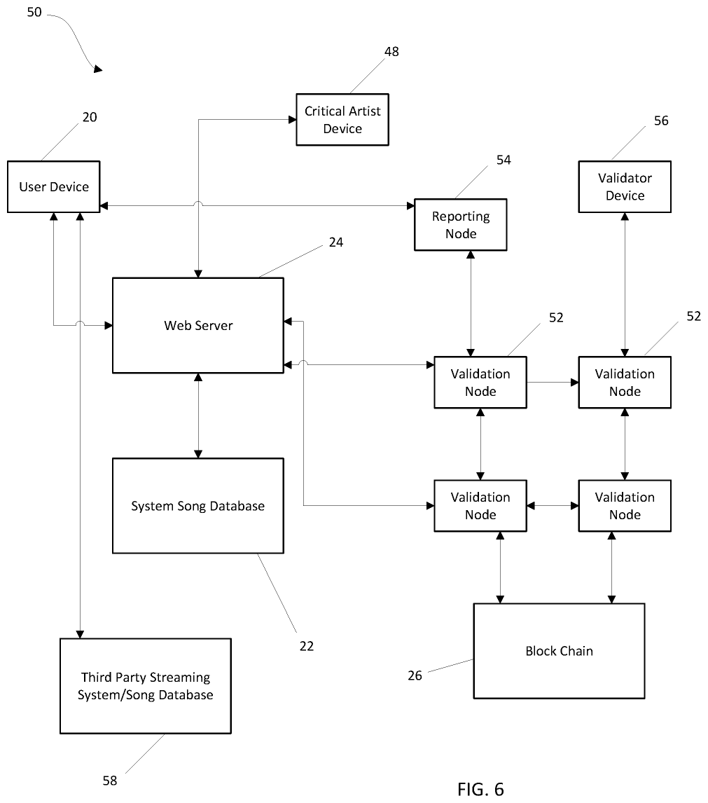

The artist then uploads the song to the song database 22 of the system using a web server 24 and a user computing device 20 (see FIG. 6 and step 6 of FIG. 1). The user computing device 20 is operatively coupled to the web server 24 and song database 22 using a telecommunication channel which may be, by non-limiting example, the internet, a wireless connection, a wired connection, an Ethernet connection, a fiber optic connection, a radio connection, or any other telecommunication channel type. The user computing device 20 may be any of a wide variety of computing devices, including, by non-limiting example, a smartphone, a desktop computer, a laptop computer, a server computer, a portable computer, a cellphone, or any other computing device capable of interacting with the web server and/or the song database. In some method implementations, a copy of the copyright registration certificate may be required to be uploaded with the song. In some implementations, the artist may be required to submit a signed affidavit that establishes, by non-limiting example, the artist's ownership of the song, the song's provenance, the existence of a copyright registration for the song, the evidence of a copyright registration for the song, a licensing number for a copyright validation service for the song, or any other required evidence of ownership/authorship/joint authorship of the artist (step 8). In some implementations, the system may provide the artist and any joint authors or co-artists with the legal documentation to assign the copyright in the song to the artist/system as needed to legally enable the system to create an NFT of the song and stream it to users, while creating a right to receive compensation via financial non-fungible tokens distributed to accounts in the system associated with the artist and any joint authors or co-artists. This process will be discussed further in this document.

Following the provision of the evidence of ownership of the copyright in the song to the system, the system may, in various method implementations, conduct an independent intellectual property rights check of the song (step 10) to detect evidence of plagiarism or other copying in the content of song. This IP rights check may be carried out by the system itself or the system may utilize the resources of a third party performing rights organization service provider to carry out this analysis, such as, by non-limiting example, the Harry Fox Agency, Rumble Fish, or any other performing rights verification/clearing service.

As part of/during the upload process the artist will identify a title for the song and a selection of a musical category or musical genre for the song (step 14). This may take place prior to the IP rights check or afterward in various implementations.

In some method implementations, the system receives a certain amount of currency or cryptocurrency as an upload fee from the artist (10 USD in a particular implementation). The funds from this upload fee go to fund the operation of the musical distribution system itself. Either prior to or contemporaneously with the completion of the IP rights check in step 10, the system receives funds from an account associated with the artist for a desired number of critiques for the song by critical artists associated with the system (step 12). The system may receive the funds in the form of currency issued by a governmental agency or as cryptocurrency. The cryptocurrency utilized by the system may be a proprietary currency associated with a block chain utilized by the system itself as discussed in the '700 Provisional or may be any of a wide variety of other cryptocurrencies such as, by non-limiting example, Bitcoin, Ether, Algorand, or any other cryptocurrency type. The number of critiques purchased may, in particular implementations, be tiered with the artist having the ability to buy 100 critiques at a time. In a particular system implementation, a song may be regarded as being mature or ready for distribution in the system when it has received at least 1000 critiques by unique critical artists. So an artist may start by purchasing 100 critiques, and, if the feedback from the first 100 critiques is promising, buy the additional critiques. Each of these critiques is rendered by a critical artist whose performance and ability to “pick a hit” is objectively measured by comparison to other critical artists, rendering the feedback as objective as possible, as will be discussed further in this document.

As illustrated in FIG. 1, the method includes the system receiving a selection of a percentage of the ownership of the NFT of the song that will be shared by the artist(s) (step 16). The artist has complete control as to whether to share any or all of the ownership in the NFT and with whom to share it. In a particular method implementation, the ownership sharing may take place with the critical artists themselves, who are given the first right of refusal to purchase the shared ownership in the form of financial non-fungible tokens (FNFTs) after critiquing the song (as will be discussed further). However, in other method implementations, any or all of the shared ownership could be shared with, by non-limiting example, a charity, an organization, an individual, a family, a group of individuals, one or more users of the system, a foundation associated with operating the system, or any other legal individual or organization. In a particular implementation, the artist may retain 60% of the ownership and share 40% of the ownership. After the initial selection of ownership sharing, the artist is free to sell more of the retained ownership, but in particular implementations, those who already own the shared FNFTs for the song have the first right of refusal to purchase the FNFTs before they can be transferred to others.

Following receipt of all of the information including the ownership percentage sharing, the system then generates an NFT of the song along with a set of associated FNFTs, allocating the FNFTs to the artist and the shared owner(s) using the web server 24 and the block chain 26 (see FIG. 6 and step 18). At this stage in the process, the shared owner(s) may not be identified as the shared FNFT have not yet been purchased or made available for purchase at this point. The NFT and FNFTs are constructed and recorded using a block chain associated with the system which, in the case of the implementations disclosed in this document, is one formed using snapshot hashing using the processes disclosed in the '700 Provisional and Appendix A. The FNFT is a smart contract that uses the block chain to record the ownership of the FNFT and the system uses the smart contract to provide the accounts or addresses associated with the FNFT owner(s) with the revenues in cryptocurrency or currency of the song. Since the FNFT is a smart contract, the revenues can be immediately allocated to the owners of the FNFTs by way of the block chain system and recorded in a public an immutable way using the blocks of the block chain system without requiring additional human execution.

In various method implementations, following creation of the NFT of the song, the NFT itself is staked on the block chain using the block chain system. The NFT then remains staked while ownership of the rights to receive revenues from the NFT are then allocated using the FNFTs (tokens) through changes in ownership rights/rights to receive revenues of each of the FNFTs. While the NFT is described as being staked in this manner, in other system and method implementations, it may not be staked, but may be placed on a separate network or represented using a stable coin associated with the block chain of the system. A wide variety of method and system implementations are possible using the principles disclosed herein.

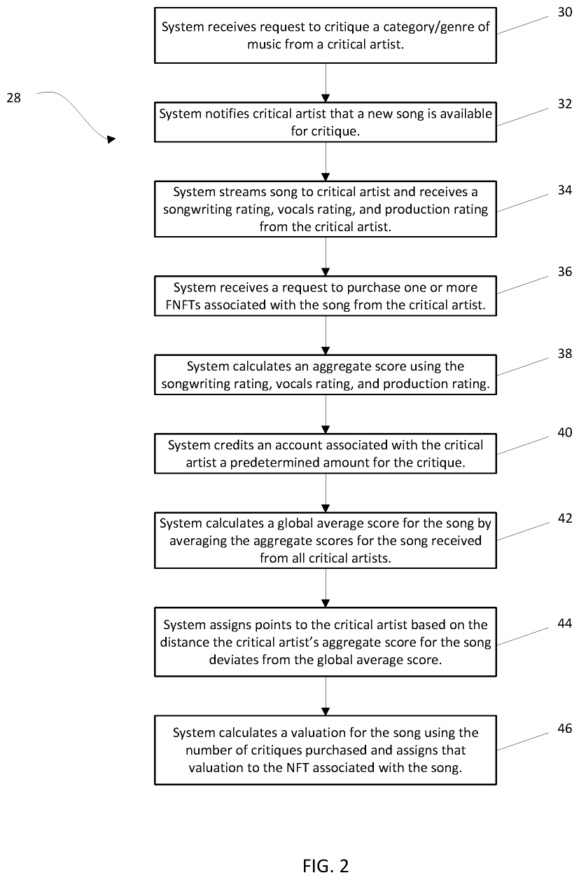

Various system and method implementations employ various implementations of methods of providing critiques of songs associated with NFTs using critical artists. Referring to FIG. 2, a flow chart of an implementation of a method of providing a critique 28 is illustrated. As illustrated, the system, at the web server 24 from a critical artist computing device 48, receives a request to critique a particular category or genre of music from a critical artist. This request generally comes when the critical artist initially enrolls with the system. In various method implementations, critical artists may be allowed to critique only one category or genre of music until a certain demonstrated level of critiquing performance has been established over a period of time. In various system and method implementations, it is possible for a critical artist to eventually critique multiple categories of music over a period of time. In other implementations, it is believed that certain critical artists, through their ability to pick songs that have a broad positive appeal to the listening public, will be able to rise to form tiers of critical artists whose critiques, at higher tiers, can cost artists more and provide more credibility for the song being critiqued. The system then notifies the critical artist using the web server 24 and the critical artist computing device 48 that a song in the artist's particular genre is available for critique (step 32). This may be done using a computing interface generated on the critical artist computing device like that illustrated in Appendix A, p. 21. Through the computing interface, the critical artist selects the song, and requests that the web server 24 and system song database 22 to stream the song to the critical artist computing device 48 to begin the critiquing process (step 34).

During the playback of the song, the critical artist may provide at least a songwriting rating and a vocals rating (where the song is unproduced, these are the only ratings provided). If the song is produced, the critical artist also provides a production rating using the critical artist computing device 48. In various implementations, the computing interface of the critical artist computing system may be designed to not accept a rating entry until at least two minutes of a song have been streamed, though this value could be lower or higher or the critical artist may be required to listen to the entire song before entering a rating. In a particular implementation, each of the songwriting rating, the vocals rating, and the production rating are scored as integer values between 1 and 10 and the scores for each rating added together and divided by three to produce an aggregate score for the song (step 38). This division by three may also be followed in various method implementations where the song is not produced and a production rating has not yet been provided to ensure that unproduced songs do not have the ability to get ratings as high as produced songs (as a way of encouraging artists to take the feedback on the unproduced song and then spend the resources to have an unproduced song that is positively received produced and re-introduced into the system). In various implementations, following the division by three, the method may round the aggregate score up to the closest integer value, down to the closest integer value, or may keep the value in decimal form. These calculations may be performed by the web server 24, the critical artist computing device 48, or both in various implementations.

Where the critical artist favorably rates the song (i.e., the song has an aggregate rating high enough for the critical artist to wish to take advantage of purchasing one or more FNFTs shared by the artist), the critical artist can enter a request using the critical artist computing device 48 to purchase the desired number of shared FNFTs. This allows the critical artist to own a “piece of the action” in advance of the song being released for listening to the purchasing public. The pricing of the FNFTs may be calculated using various methods, including, by non-limiting example, an introductory pricing model, a preliminary pricing model, the valuation model discussed later on in this document, or any other method for calculating an initial price for the FNFTs. Where the valuation model discussed later on in this document is used to calculate the ultimate price for the FNFTs, the system may deduct the price of the FNFT(s) purchased by the critical artist after the valuation has been done. In some method implementations, a discount percentage may be applied to the final valuation amount to incentivize critical artists to invest in the songs they have rated highly.

Following the entry of the aggregate score for the song for the particular critical artist, the system (via the web server/block chain system) credits an account associated with the critical artist a predetermined amount for the critique (step 40). In particular implementations, the amount may be credited in currency or cryptocurrency. In some implementations, the critique may pay 0.50 USD to the critical artist. In this way, there is a financial incentive to critique songs even if those songs ultimately do not receive an aggregate score high enough for the critical artist to want to purchase FNFTs and invest in the song. However, the financial incentive may be set low enough to encourage critical artists to purchase shared interests as a way of maximizing their potential return in the time spent reviewing the songs.

To keep the critiquing process honest/objective, a large number of critical artists rate each song and the aggregate rating produced by each critical artist is compared with an average of all of the aggregate ratings provided for that song. This is accomplished by the system (via the web server 24) calculating a global average score for the song by averaging the aggregate scores/ratings provided by all of the unique critical artists (step 42). In various implementations, the method may round the global average score down to the nearest integer value, up to the nearest integer value, or may keep the score a decimal value. The system then calculates a numerical distance between the aggregate rating provided by each critical artist and the global average score by subtracting the two values. In various implementations, the absolute value of the difference may be taken so that the order of subtraction of the global average score and the aggregate rating may not affect the results. In a particular method implementation, points are assigned to the critical artist for the song based on the distance the critical artist's aggregate score for the song deviates from the global average score (step 44).

In an implementation, two points are assigned if the numerical distance is zero (i.e., the critical artist's aggregate score is identical to the global average score), one point is assigned if the numerical distance is one, zero points assigned if the numerical distance is two, and −1 points are assigned if the numerical distance is three. Note that the point scoring in this method implementation does not depend on whether the critical artist's aggregate score was lower or higher than the global aggregate score, just how far away it was. This method implementation uses integer values for the numerical distance and so would work in method implementations where the aggregate score and global aggregate score are also integers. If decimal values are used for the aggregate score and global aggregate score, ranges of decimal numerical distances may be used to assign points, or points may be assigned using a continuous function that comprehends the exact decimal numerical distances.

The ability of the critical artist to continue to provide critiques of songs depends on the critical artist's point count and various threshold values for point counts/trends may be utilized in various system implementations to eliminate critical artists who are not good as the average in rating songs. Additional threshold values may also be used to allow critical artists to move upwardly in to various tiers with those most accurate critical artists moving into one or more higher tiers and receiving associated incentives (higher compensation per critique, more options to buy FNFTs, options to buy FNFTs at discounted pricing, additional block rewards (as discussed later), or any other incentive to encourage engagement by the critical artists.

In various method implementations, the method may include calculating a valuation of the song immediately post-critiquing by a predetermined number of critical artists (either the total number of critiques purchased by the artist or 1000 critiques, depending on the implementation). The system then uses that valuation to assign a valuation to the NFT associated with the song (FIG. 2, step 46, which then sets a value for the various FNFTs/tokens associated with the NFT). A particular method implementation includes assigning a currency value to each possible aggregate score where the aggregate scores are integer values between 1 and 10. The method also includes multiplying the count of identical aggregate scores provided by the plurality of critical artists who rated the song at each integer value by the currency value to form a set of aggregate score valuations. The method also includes adding the set of aggregate score valuations to form a total valuation, dividing the total valuation by a total number of aggregate scores provided by the plurality of critical artists to form an average assigned value for the song, and subtracting the average assigned value for the song from a total amount of currency paid by the artist for the total number of aggregate values to form a surplus value. Where the surplus value is positive, the surplus value may be retained by the system and used to pay system operating expenses and promotions offered. Where the surplus value is negative, then an account associated with the artist is credited with an amount of cryptocurrency equal to the value of the surplus value as a promotion (the system being the entity providing the cryptocurrency).

In particular method implementations, a non-zero currency value is only assigned to aggregate scores between 4 and 10. This means that songs with aggregate scores of 1, 2, and 3 add zero currency value to the calculation. In various method implementations, it may be statistically impossible for a valuation distribution constructed using 1000 critiques for 1000 songs for any song to have an aggregate score rating of 10 or an aggregate score rating of 1. However, the system may offer the incentive that if a song received such a 10 rating, it would be, by non-limiting example, subject to an automatic surplus of 100,000 USD which would be credited to the artist as a promotion. A wide variety of promotional amounts and currency amount distributions may be determined using the principles disclosed in this document. In some system implementations, the currency amount distributions may be determined by category/genre and may be a function of how users stream songs in that category/genre to reflect that less popular category/genre songs are less valuable overall. Table 1 contains an example of a valuation distribution constructed using 1000 critiques for 1000 songs:

TABLE 1

| | Currency | Total number | Aggregate score |
|---|---|---|---|
| Song | Valuation | of aggregate | valuation |
| Rating | (USD) | scores | (USD) |
| 10 | 100,000 | N/A | 100,000 (paid as a promotion) |
| 9 | 1000 | 10 | 10,000 |
| 8 | 900 | 30 | 27,000 |
| 7 | 700 | 80 | 56,000 |
| 6 | 500 | 120 | 60,000 |
| 5 | 400 | 250 | 100,000 |
| 4 | 50 | 300 | 15,000 |
| 3 | 0 | 200 | 0 |
| 2 | 0 | 10 | 0 |
| 1 | 0 | N/A | N/A |
| | Total | 1000 | 268,000 |

Here, dividing the total valuation by the 1000 critiques provided gives a valuation for the NFT of 268 USD. If the artist paid 510 USD to obtain the 1000 critiques, as a non-limiting example, this leaves 242 USD as a positive surplus value which would be retained by the system to fund operations and promotions. The ability to assign a valuation to the NFT of the song post-critique whether in currency or cryptocurrency may further facilitate speculation in the FNFTs associated with songs on the system by critical artists and members of the listening public (and others who can purchase the FNFTs) along with speculation activity in the cryptocurrency itself.

Referring to FIG. 6, the block chain system components of the music distribution system 50 include a block chain 26 that is constructed/managed by a set of validation nodes 52 which work to validate and add blocks to the block chain 26 along with one or more reporting nodes 54 which receive hash data from user device 20 using processes to be discussed in more detail later in this document. A validator (who may be associated with one or more of the validation nodes in various system implementations) communicates with the validation node(s) using validator computing device 56. In various system implementations, the validation nodes 52 and reporting notes 54 may take turns functioning in these particular capacities depending on which user is currently streaming using the system. In various system implementations, external third party streaming systems/song databases 58 can be used to help generate hash data (as will be described further) by being operatively coupled via a telecommunication channel to user device 20. The components used for the web server 25, system song database 22, reporting node(s) 54, and the validation nodes 52 may each include, by non-limiting example, a single computing device, multiple computing devices, a server, a desktop, a cloud computing resource, a portable computing device, or any other computing device with sufficient power and/or resources to perform the function of each component.

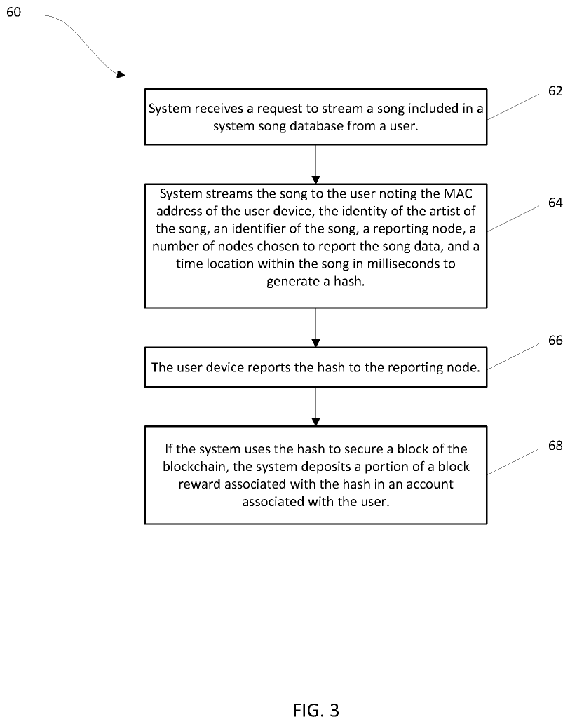

Referring to FIG. 3, a first implementation of a method of rewarding a user for streaming a song 60 is illustrated. As illustrated, the system receives a request to stream a song included in the system song database 22 from the user computing device 20 (step 62). The request may come by the user utilizing a computing interface on the user computing device 20 formed by computer readable instructions in a memory of the user computing device executed by a processor coupled with the memory. A non-limiting example of the computing interface may be any of those illustrated in Appendix A, page 20. The system then streams the song to the user while noting (via the web server 24, the user computing device 20, or both) hashing data/hash data.

In various method implementations, the hashing data includes, by non-limiting example, a media access control address (MAC address) of the user computing device 20, an identity of the artist of the song being streamed, a system identifier of the song (in the song database), a reporting node of the block chain system, a number of nodes in the block chains system chosen to report the song data, an a time location within a duration of the song in milliseconds (step 64). Other data relating to the stream, the song, the devices, or the block chain system itself may be included as hashing data, and the process of collecting and using the hashing data at a snap shot in time of the song streaming may be referred to as snapshot hashing (or snap hashing). The hashing data is then used by the system to generate a hash which is reported by the user device (in the form of hashing data or the hash itself) unidirectionally to the reporting node (step 66). The system then adds the hash to a set of available hashes for use in securing a new block of the block chain 26 associated with the block chain system. If the system uses the hash to secure a block of the block chain, the system deposits a portion of a block reward associated with the hash in an account associated with the user. Because multiple hashes may be involved in developing the ultimate hash used to secure the block of the block chain, the block reward may be divided among all of the users who provided a hash that was used. In this way, the users are rewarded for listening to what is, to them, free streaming music. The method implementation illustrated in FIG. 3 is used when the song being listed to is part of the song database of the system itself.

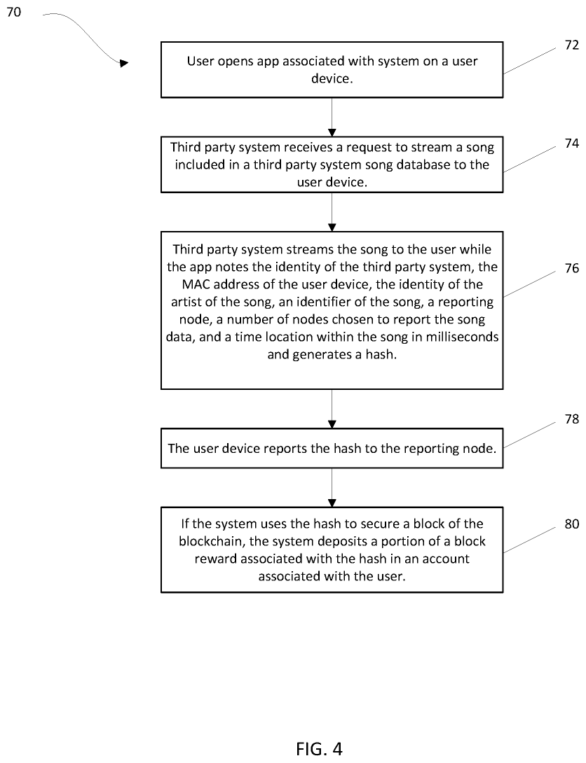

Referring to FIG. 4, a flow chart of another implementation of a method of rewarding a user for streaming a song 70 is illustrated where the song being streamed is located on a third party system. Here, the user opens an app included as computer readable instructions stored in a memory of the user computing device 20 that includes any of the interface designs previously disclosed in this document (step 72). With the app open, the user then requests a third party system to stream a song from the third party system's song database to the user device (step 74). This may be done using an app provided by the third party system. As previously described, while the third party system streams the song to the user device 20, the app (via the user device 20) notes hashing data.

In this method implementation, the hashing data includes, by non-limiting example, the identity of the third party system, the MAC address of the user device, the identity of the artist of the song, an identifier of the song (either in the third party system database or an equivalent determined by the system) a reporting node, a number of nodes chosen to report the song data, and a time location within the song in milliseconds. Additional song, third party system, system, or user device data types may be utilized in various implementations to form the hashing data. The user device 20 then uses the hashing data to form a hash which is then unidirectionally reported to the reporting node 54 (step 78). The use of unidirectional reporting can prevent hacking of the hashes as hackers do not have the ability to get any information from the reporting node itself regarding the hash structure or characteristics using a compromised user device or get into the reporting node to intercept and modify hashes being provided. As previously described, if the system uses the hash reported by the user to secure a block of the block chain, the system deposits a portion of the block reward in an account associated with the user. In this way, any of a wide variety of third party streaming services can be used to allow users to listen to any song provided by the third party streaming service and obtain hash rewards, while the music distribution system continues to generate blocks in the block chain to use in recording transactions and forming NFTs and FNFTs for songs in its song database. Thus the users are rewarded for using any streaming system provided the app is open on their computing device.

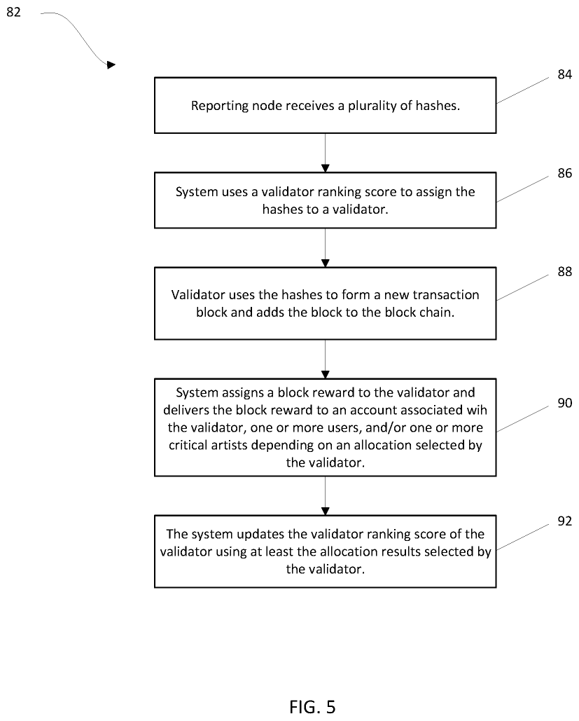

Referring to FIG. 5, a flow chart of an implementation of a method of rewarding validators of blocks of the block chain 82 is illustrated. In various system implementations a certain number of validators are used to perform the validation function for each block of the block chain. In a particular implementation, the number of validators may be about 40 though it could be larger or smaller depending on the size of the system and the number of transactions taking place. The validators compete with each other for the opportunity to validate blocks because they receive a portion of the block reward when they are chosen to validate a particular block. As illustrated in FIG. 5, a reporting node 54 receives a plurality of hashes (step 84) and the system (via the web server or the validation nodes) uses a validator ranking score to assign the plurality of hashes to a particular validator associated with a validator computing device 56 (step 86). The ranking score is a function of various variables, including, by non-limiting example, a percentage of block rewards shared with users (higher percentage sharing increases the ranking), any misbehavior by the validator, up time provided by the validator, historical numbers of blocks secured by the validator, a percentage of block rewards shared with critical artists (higher percentage sharing increases the ranking), the total amount of block rewards distributed to users and critical artists by the validators, and what the validator is currently offering to users and critical artists in block award sharing. Because some of these numbers vary fluidly over time, it is expected that a natural validator rotation will take place with different validators processing the plurality of hashes to construct different blocks of the block chain. This also means that the validator ranking scores will also vary over time.

The validator then uses the hashes to form a new transaction block and adds the block to the block chain 26 (step 88). In response, the block chain system assigns a block reward to the validator and delivers the block award in an apportioned fashion to an account associated with the validator, one or more users, and/or one or more critical artists depending on the allocation currently set by the validator (step 90). The system then updates the validator ranking score of the validator using at least the last used block award allocation results selected by the validator (step 92). A wide variety of possibilities for using validators to add to the block chain and process hashes generated by users may be constructed using the principles disclosed in this document. In various method implementations, one of the incentives provided to critical artists can be the opportunity to become a validator in addition to being a critical artist. In this way, the critical artist can receive income from both critiquing and validating.

In places where the description above refers to particular implementations of music distribution systems and related methods and implementing components, sub-components, methods and sub-methods, it should be readily apparent that a number of modifications may be made without departing from the spirit thereof and that these implementations, implementing components, sub-components, methods and sub-methods may be applied to other music distribution systems and related methods.

What is claimed is:

1. A method of generating a non-fungible token of a song, the method comprising:
receiving an upload of a song from an artist using a web server;
receiving proof of copyright registration from the artist using a web server;
performing an intellectual property rights check using the song and the web server;
receiving funds from the artist for a desired number of critiques of the song using the web server;
receiving a selection of a category of the song from the artist using the web server;
receiving, from the artist using the web server, a selection of a percentage of ownership of a non-fungible token of the song available for sharing;
generating the non-fungible token of the song along with an associated predetermined number of financial non-fungible tokens using the web server and a block chain system coupled thereto; and
allocating the financial non-fungible tokens according to the selection of the percentage of ownership of the non-fungible token using the block chain system.

2. The method of claim 1, wherein proof of copyright registration is a copyright registration certificate.

3. The method of claim 1, wherein proof of copyright registration comprises an affidavit of authorship by the artist.

4. The method of claim 1, wherein the block chain system comprises blocks formed using snapshot hashing.

5. The method of claim 1, wherein the percentage of ownership is between zero percent and 40 percent and the ownership is divided between one of a critical artist, a co-artist, a recording artist, a charity, or any combination thereof.

6. A method of providing a critique of a song associated with a non-fungible token, the method comprising:
providing a notification to a critical artist that a song is available for critique in a song database using a web server and a critical artist computing device;
in response to a request from the critical artist provided by the critical artist computing device, streaming the song to the critical artist computing device for review by the critical artist using the web server and the song database;
receiving at least a songwriting rating and a vocals rating from the critical artist using the critical artist computing device and the web server;
receiving a request to purchase one or more financial non-fungible tokens associated with a non-fungible token of the song from the critical artist computing device;
calculating an aggregate score for the song using at least the songwriting rating and the vocals rating using the web server;
crediting an account associated with the critical artist a predetermined amount of cryptocurrency after receiving at least the songwriting rating and the vocals rating using the web server and a block chain system;
calculating a global average score for the song by averaging a plurality of aggregate scores for the song received from a plurality of critical artists using the web server;
assigning points to the critical artist based on a numerical distance the aggregate score for the song deviates from the global average score using the web server;
calculating a valuation of the non-fungible token of the song using a total number of critiques purchased by the artist of the song using the web server; and
assigning the valuation to the non-fungible token using the web server and the block chain system.

7. The method of claim 6, further comprising receiving a request to purchase one or more financial non-fungible tokens associated with a non-fungible token of the song from the critical artist computing device.

8. The method of claim 6, wherein receiving at least a songwriting rating and a vocals rating from the critical artist further comprises receiving a production rating.

9. The method of claim 6, wherein calculating a valuation of the non-fungible token of the song further comprises, using the web server:
assigning a currency value to each possible aggregate score of a plurality of aggregate scores, the plurality of aggregate scores comprising integer values between 1 and 10;
multiplying a count of identical aggregate scores provided by the plurality of critical artists critiquing the song at each integer value by the currency value to form a set of aggregate score valuations;
adding the set of aggregate score valuations to form a total valuation;
dividing the total valuation by a total number of aggregate scores provided by a plurality of critical artists critiquing the song to form an average assigned value for the song; and
subtracting the average assigned value for the song from a total amount of currency paid by the artist for the total number of aggregate scores to form a surplus value.

10. The method of claim 9, wherein if the surplus value is positive, then the surplus value is retained and used to pay expenses and promotions offered using the web server and the block chain system.

11. The method of claim 9, wherein if the surplus value is negative, then an account associated with an artist of the song is credited with an amount of cryptocurrency equal to a value of the surplus value as a promotion.

12. The method of claim 9, wherein a non-zero currency value is only assigned to aggregate scores of between 4 and 10.

13. The method of claim 6, wherein assigning points to the critical artist based on the numerical distance the aggregate score for the song deviates from the global average score further comprises:
assigning two points if the numerical distance is zero;
assigning one point if the numerical distance is one;
assigning zero points if the numerical distance is two; and
assigning negative one points if the numerical distance is three.

14. The method of claim 13, wherein if the numerical distance is zero, the method further comprises awarding a portion of a block reward in cryptocurrency to the account associated with the critical artist.

15. A method of rewarding a user for streaming a song, the method comprising:
receiving a request to stream a song comprised in a song database at a web server from a user utilizing a user computing device;
streaming the song to the user computing device using the web server and the song database;
during streaming, using the user computing device, recording hashing data, the hashing data comprising at least a media access control address (MAC address) of the user computing device, an identity of an artist of the song, a system identifier of the song, a reporting node of a block chain system, a number of nodes of the block chain system chosen to report song data, and a time location within a duration of the song in milliseconds;
reporting the hashing data to the reporting node of the block chain system using the user computing device;
forming a hash with the hashing data using the block chain system;
if the block chain system uses the hash to secure a block of the block chain, depositing a portion of a block reward associated with the hash in cryptocurrency in an account associated with the user.

16. The method of claim 15, wherein the song database is a third party song database controlled by a third party and the hashing data further comprises an identity of the third party.

17. The method of claim 15, wherein computer readable instructions are comprised in a memory of the user computing device and configured to enable the recording of hashing data in the memory.

18. The method of claim 15, wherein a direction of reporting of the hashing data to the reporting node is only from the user computing device to the reporting node.

19. The method of claim 15, wherein each block of the block chain system is formed using snapshot hashing carried out by the block chain system.

20. The method of claim 15, wherein the portion of the block reward provided by the account of the user is determined by an allocation set by a validator of the block chain system.
